(19) United States
(12) Patent Application Publication
(10) Pub. No.: US 2025/0037269 A1
(43) Pub. Date: Jan. 30, 2025

(54) INSPECTION APPARATUS AND METHOD FOR GENERATING INSPECTION IMAGE

(71) Applicant: NuFlare Technology, Inc., Yokohama-shi (JP)

(72) Inventor: Shinji SUGIHARA, Tokyo (JP)

(73) Assignee: NuFlare Technology, Inc., Yokohama-shi (JP)

(21) Appl. No.: 18/910,271

(22) Filed: Oct. 9, 2024

Related U.S. Application Data
(63) Continuation of application No. PCT/JP2023/008846, filed on Mar. 8, 2023.

(30) Foreign Application Priority Data
Jul. 20, 2022 (JP) 2022-115678

(51) Int. Cl. G06T 7/00; G01N 23/2251; G06T 7/13; G06T 7/73

(52) U.S. Cl. CPC G06T 7/001; G01N 23/2251; G06T 7/13; G06T 7/73; G01N 2223/204; G01N 2223/401; G01N 2223/6116; G06T 2207/10061; G06T 2207/30148

(57) ABSTRACT

According to one embodiment, an inspection apparatus includes a two-dimensional direction filtering process circuit performing a filtering process for each of pixels of the image, using a plurality of two-dimensional direction filters corresponding to different filter angles, a contour extraction circuit extracting, as a contour point candidate pixel, a pixel in which at least one of intensities for each of the filter angles calculated by the filtering process is larger than a threshold value set for each of the filter angles, a normal direction calculation circuit converting the intensities for each of the filter angles into polar coordinates in the contour point candidate pixel and calculate an angle in a first direction based on a result of the conversion into polar coordinates, a contour point coordinate calculation circuit calculating coordinates of a contour point in the contour point candidate pixel, based on a one-dimensional profile in the first direction.

### CROSS-REFERENCE TO RELATED APPLICATIONS

This application is a Continuation application of PCT Application No. PCT/JP2023/008846, filed Mar. 8, 2023, and based upon and claiming the benefit of priority from Japanese Patent Application No. 2022-115678, filed Jul. 20, 2022, the entire contents of all of which are incorporated herein by reference.

### FIELD

The present invention relates generally to an inspection apparatus for inspecting a defect in a pattern formed on a sample and a method for generating an inspection image.

### BACKGROUND

In a process of manufacturing a semiconductor device, a circuit pattern is transferred onto a semiconductor substrate by reduced exposure using an exposure apparatus (also referred to as a “stepper” or a “scanner”). In the exposure apparatus, a mask (also referred to as a “reticle”) on which an original pattern is formed is used to transfer a circuit pattern onto a semiconductor substrate (also referred to as a “wafer” hereinafter).

For example, state-of-the-art devices require formation of circuit patterns with line widths of a few nanometers. As the circuit patterns become miniaturized, original patterns in the mask also become miniaturized. Therefore, a mask defect inspection apparatus is required to achieve high defect detection performance corresponding to the miniaturized original patterns.

The defect inspection method includes a die to database (D-DB) inspection method of comparing an inspection image based on an image (a captured image) obtained by capturing a sample (a mask, wafer, and etc.) with a reference image based on design data and a die to die (D-D) inspection method of comparing a plurality of regions formed on the sample and having the same pattern.

The defect inspection apparatus extracts the contour line of a pattern from the captured image to generate an inspection image. The defect inspection apparatus detects a defect by comparing the contour line of the pattern of the inspection image with that of the pattern of the reference image.

For example, Patent Literature 1 (Jpn. Pat. Appln. KOKAI Publication No. 2022-16779) discloses a method of extracting a contour line from a captured image using a plurality of two-dimensional spatial filter functions having different directivities. In this case, a filtering process is performed for each direction in each frame image (pixel). Then, if at least one of the values (filtered intensities) obtained for the respective directions is larger than a threshold value, the pixel is extracted as a candidate for a pixel including a contour line (contour pixel candidate).

For example, if the captured image has an asymmetric image profile, that is, if the captured image has directional dependency, the directional dependency occurs in the filtered intensity. If, therefore, the filtered intensities in all directions are determined using the same intensity threshold value, the intensity threshold value needs to be set to a relatively small value in accordance with the direction in which the intensity is lowered. If, however, the intensity threshold value is decreased, noise is highly likely to be detected to cause false contouring increases. If, furthermore, the normal direction of a contour line is determined based on the magnitude of the filtered intensity, the normal direction is highly likely to be calculated erroneously because the filtered intensity has directional dependency.

The present invention has been made in view of the above points. That is, the inspection apparatus of the present invention can set different intensity threshold values in their respective directions. The inspection apparatus can also calculate an angle in the principal axis direction of an equivalent ellipse as an angle in the normal direction based on the result of converting the relationship between the filtered intensity and the filter angle into polar coordinates. It is therefore an object to provide an inspection apparatus and an inspection image generation method which are capable of improving the accuracy of extraction of the contour line of an inspection image because the detection of the contour line and the determination of the normal direction are processed independently of each other.

### SUMMARY

According to a first aspect of the invention, an inspection apparatus includes: an imaging mechanism configured to capture an image of a wafer or a mask; a two-dimensional direction filtering process circuit configured to perform a filtering process for each of pixels of the image, using a plurality of two-dimensional direction filters corresponding to different filter angles; a contour extraction circuit configured to extract, as a contour point candidate pixel, a pixel in which at least one of intensities for each of the filter angles calculated by the filtering process is larger than a threshold value set for each of the filter angles; a normal direction calculation circuit configured to convert the intensities for each of the filter angles into polar coordinates in the contour point candidate pixel and calculate an angle in a first direction based on a result of the conversion into polar coordinates; a contour point coordinate calculation circuit configured to calculate coordinates of a contour point in the contour point candidate pixel, based on a one-dimensional profile in the first direction; a reference image generation circuit configured to generate a reference image; and a comparison circuit configured to compare the reference image with an inspection image based on the contour point.

According to a second aspect of the invention, a method for generating an inspection image includes: performing a filtering process for each of pixels of a captured image of a wafer or a mask, using a plurality of two-dimensional direction filters corresponding to different filter angles; extracting, as a contour point candidate pixel, a pixel in which at least one of intensities for each of the filter angles calculated by the filtering process is larger than a threshold value set for each of the filter angles; converting the intensities for each of the filter angles into polar coordinates in the contour point candidate pixel; calculating an angle in a first direction based on a result of the conversion into polar coordinates; and calculating coordinates of a contour point in the contour point candidate pixel, based on a one-dimensional profile in the first direction.

### BRIEF DESCRIPTION OF THE DRAWINGS

FIG. 1 is a diagram showing an overall configuration of an inspection apparatus according to an embodiment.

FIG. 2 is a block diagram of a contour extraction circuit included in the inspection apparatus according to the embodiment.

FIG. 3 is a diagram showing an example of filter angles of a two-dimensional direction filter in the inspection apparatus according to the embodiment.

FIG. 4 is a diagram showing a display example of pixel values of 5×5 pixels with a pixel of interest centered in the inspection apparatus according to the embodiment.

FIG. 5 is a diagram showing a display example of matrix vectors of the two-dimensional direction filter in the inspection apparatus according to the embodiment.

FIG. 6 is a diagram showing specific examples of two-dimensional direction filters F1 to F4 in the inspection apparatus according to the embodiment.

FIG. 7 is a diagram showing specific examples of two-dimensional direction filters F5 to F8 in the inspection apparatus according to the embodiment.

FIG. 8 is a flowchart of an inspection process in the inspection apparatus according to the embodiment.

FIG. 9 is a diagram showing a specific example of 4×4 pixels including a contour line of an inspection image and a contour line of a reference image in a comparison step in the inspection apparatus according to the embodiment.

FIG. 10 is a flowchart of a contour extraction process in the inspection apparatus according to the embodiment.

FIG. 11 is a graph showing the relationship between a filter angle and filtered intensity in the inspection apparatus according to the embodiment.

FIG. 12 is a graph showing polar coordinates into which the relationship between the filtered intensity and filter angle shown in FIG. 11 is converted.

FIG. 13 is a graph showing a specific example of sampling points extracted in the inspection apparatus according to the embodiment.

FIG. 14 is a graph showing a specific example of gradation values at sampling points in the inspection apparatus according to the embodiment.

FIG. 15 is a graph showing a specific example of filtered intensity after an edge filtering process of a one-dimensional profile shown in FIG. 14.

FIG. 16 is a graph showing a specific example of applying spline interpolation to the filtered intensity shown in FIG. 15.

FIG. 17 is a diagram showing a specific example of setting as a contour point the maximum value of the filtered intensity by the spline interpolation shown in FIG. 16.

FIG. 18 is a diagram showing a specific example of an isolated contour point in the inspection apparatus according to the embodiment.

FIG. 19 is a diagram showing a specific example of an adjacent contour point in the inspection apparatus according to the embodiment.

### DETAILED DESCRIPTION

An embodiment will be described below with reference to the drawings. The embodiment exemplifies an apparatus and a method for embodying the technical concept of the invention. The drawings are schematic or conceptual, and the dimensions, ratios, etc., used in the drawings are not necessarily the same as the actual ones. The technical concept of the present invention is not specified by the shape, configuration, arrangement, or the like of the components.

Below is a description of a defect inspection apparatus using a scanning electron microscope (referred to as an SEM hereinafter) to capture an electron beam image (also referred to as an SEM image hereinafter) of a measurement target pattern. Note that the defect inspection apparatus may capture an optical image of a pattern using an optical microscope or may capture an optical image of light reflected by or transmitted through a sample using a light-receiving element. The embodiment is directed to a case where a sample to be inspected is a mask. However, the sample may be a wafer for use in manufacturing a semiconductor device, a substrate for use in a liquid crystal display device, or the like as long as a pattern is formed on the surface of the sample.

### 1. Overall Configuration of Inspection Apparatus

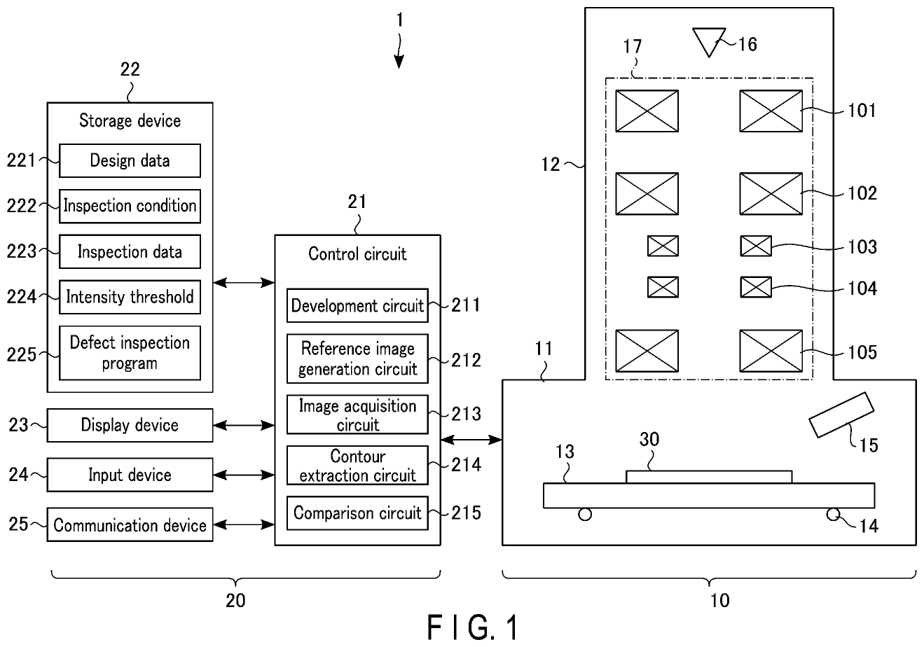

First, an example of the overall configuration of the inspection apparatus will be described with reference to FIG. 1. FIG. 1 is a diagram showing the overall configuration of the inspection apparatus 1.

As shown in FIG. 1, the inspection apparatus 1 includes an imaging mechanism 10 and a control mechanism 20.

The imaging mechanism 10 includes a sample chamber 11 and a lens barrel 12. The lens barrel 12 is set on the sample chamber 11. For example, the lens barrel 12 has a cylindrical shape extending perpendicularly to the sample chamber 11. The sample chamber 11 and lens barrel 12 are open on their mutually contacting surfaces. The space formed by the sample chamber 11 and lens barrel 12 is maintained in a vacuum (low pressure) state using a turbo molecular pump or the like.

The sample chamber 11 includes a stage 13, a stage driving mechanism 14, and a detector 15.

A sample (mask) 30 is placed on the stage 13. The stage 13 is movable in the X direction parallel to the surface of the stage 13 and in the Y direction parallel to the surface of the stage 13 and intersecting the X direction. The stage 13 may also be movable in the Z direction perpendicular to the surface of the stage 13 or may be rotatable about the rotation axis on the XY plane with the Z direction as the rotation axis.

The stage driving mechanism 14 has a driving mechanism that moves the stage 13 in the X and Y directions. Note that the stage driving mechanism 14 may have, for example, a mechanism that moves the stage 13 in the Z direction or a mechanism that rotates the stage 13 around the rotation axis on the XY plane with the Z direction as the rotation axis.

The detector 15 detects secondary electrons or reflected electrons emitted from the sample. The detector 15 transmits the detected signals such as secondary electrons or reflected electrons, that is, data of the SEM image, to an image acquisition circuit 213.

The lens barrel 12 includes an electron gun 16 and an electron optical system 17, which are components of the SEM. FIG. 1 shows a configuration example of an electron optical system that irradiates the sample 30 with a single beam. Note that the SEM may be configured to irradiate the sample 30 with multiple beams.

The electron gun 16 is set so as to emit an electron beam toward the sample chamber 11.

The electron optical system 17 irradiates the sample 30 by focusing the electron beam from the electron gun 16 on a predetermined position of the sample 30. For example, the electron optical system 17 includes a plurality of focusing lenses 101 and 102, a plurality of scanning coils 103 and 104, and an objective lens 105. The electron beam emitted from the electron gun 16 is accelerated and then focused as an electron spot on the surface of the sample 30 placed on the stage 13 by the focusing lenses 101 and 102 and the objective lens 105. The scanning coils 103 and 104 control the position of the electron spot on the sample 30.

The control mechanism 20 includes a control circuit 21, a storage device 22, a display device 23, an input device 24, and a communication device 25.

The control circuit 21 controls the entire inspection apparatus 1. More specifically, the control circuit 21 controls the imaging mechanism 10 to capture an SEM image (captured image). The control circuit 21 also controls the control mechanism 20 to compare a reference image and an inspection image and detect a defect. That is, the control circuit 21 is a processor configured to perform defect inspection. For example, the control circuit 21 includes a central processing unit (CPU), a random access memory (RAM), and a read only memory (ROM), none of which is shown. For example, the CPU loads a program, which is stored in the ROM or the storage device 22 as a non-transitory storage medium, into the RAM. Then, the control circuit 21 causes the CPU to interpret and execute the program loaded in the RAM to control the inspection apparatus 1. Note that the control circuit 21 may include a CPU device such as a microprocessor, a computer device such as a personal computer, and the like. The control circuit 21 may include a dedicated circuit (dedicated processor) in which at least a part of functions is performed by another integrated circuit, such as an application specific integrated circuit (ASIC), a field programmable gate array (FPGA) and a graphics processing unit (GPU), is responsible.

The control circuit 21 includes a development circuit 211, a reference image generation circuit 212, an image acquisition circuit 213, a contour extraction circuit 214, and a comparison circuit 215. These circuits may be configured by programs executed by an integrated circuit such as a CPU, an ASIC, an FPGA, and a GPU, may be configured by hardware or firmware provided in the integrated circuit, or may be configured by individual circuits controlled by the integrated circuit. Below is a description of a case where the control circuit 21 executes the programs to implement the functions of the development circuit 211, reference image generation circuit 212, image acquisition circuit 213, contour extraction circuit 214, and comparison circuit 215.

For example, the development circuit 211 develops design data 221 stored in the storage device 22 into data for each pattern (figure) to interpret a figure code, a figure dimension, and the like indicating a figure shape of the figure data. Then, the development circuit 211 develops the design data into a binary or multivalued (e.g., 8-bit) image (also referred to as a developed image hereinafter) as a pattern formed in a grid having a predetermined quantization dimension as a unit. The development circuit 211 calculates the rate of occupancy of the figure for each pixel of the developed image. The figure occupancy rate thus calculated is a pixel value. Below is a description of a case where the pixel value of the developed image is represented by 8-bit gradation data. In this case, the pixel value of each pixel is represented by a gradation value of 0 to 255. When the pixel value is 0, the figure occupancy rate is 0%, and when the pixel value is 255, the figure occupancy rate is 100%.

The reference image generation circuit 212 performs a resizing process and corner rounding process for the developed image. The resizing process is a process of resizing the graphic pattern of the developed image. The corner rounding process is a process of rounding corner portions of the graphic pattern after the resizing process. The reference image generation circuit 212 extracts a contour from the developed image after the resizing process and corner rounding process to generate a reference image (contour image). The reference image generation circuit 212 transmits the generated reference image to the comparison circuit 215 and the storage device 22.

The image acquisition circuit 213 acquires data of an SEM image from the detector 15 of the imaging mechanism 10. The image acquisition circuit 213 transmits the data of an SEM image to the contour extraction circuit 214 and the storage device 22.

The contour extraction circuit 214 extracts contour data from the SEM image to generate an inspection image (contour image). The contour data includes information about contour points of the pattern and contour lines connecting the contour points. In other words, the contour data includes representative values of coordinates through which the contour lines pass for each pixel, that is, contour points, and information on the normal direction of the contour vector at the contour points. Details of the contour extraction circuit 214 will be described later.

The comparison circuit 215 compares the inspection image with the reference image to detect a defect. More specifically, the comparison circuit 215 aligns the inspection image and the reference image to calculate the amount of shift of the inspection image relative to the reference image. The comparison circuit 215 measures the amount of distortion of the inspection image, for example, based on the variations of the shift amount in the plane of the sample 30 to calculate a distortion coefficient. For example, it is preferable that the distortion amount is represented by a polynomial model of coordinates (X, Y) in the image and the distortion coefficient is set as a coefficient of the polynomial. The comparison circuit 215 compares the inspection image and the reference image using an appropriate algorithm in consideration of the shift amount and the distortion coefficient. If the error between the inspection image and the reference image exceeds a preset value, the comparison circuit 215 determines that there is a defect in the coordinate position of the corresponding sample 30.

The storage device 22 stores data and programs relating to inspection for defects. For example, the storage device 22 stores design data 221, inspection condition parameter information 222, inspection data 223, threshold data, and the like. For example, the inspection condition parameter information 222 includes imaging conditions of the imaging mechanism 10, reference image generation conditions, SEM image contour extraction conditions, defect detection conditions, and the like. The inspection data 223 includes image data (developed image, reference image, SEM image, and inspection image) and data (coordinates, sizes, etc.) regarding detected defects. The intensity threshold data 224 is data of intensity threshold values used to extract the contour of the SEM image. The storage device 22 also stores a defect inspection program 225 as a non-transitory storage medium. The defect inspection program 225 is a program for causing the control circuit 21 to perform inspection for defects.

The storage device 22 may include various storage devices such as a magnetic disk storage device (hard disk drive (HDD)) and a solid state drive (SSD) as external storages. The storage device 22 may further include a drive for reading programs from a compact disc (CD), a digital versatile disc (DVD), or the like as a non-transitory storage medium.

The display device 23 includes a display screen (e.g., a liquid crystal display (LCD)), an electroluminescence (EL) display, or the like. The display device 23 displays, for example, a result of defect detection under the control of the control circuit 21.

The input device 24 is an input device such as a keyboard, a mouse, a touch panel, and a button switch.

The communication device 25 is a device connected to a network in order to transmit and receive data to and from an external device. Various communication standards may be used for communication. For example, the communication device 25 receives design data from an external device and transmits a result of defect inspection and the like to the external device.

### 2 Configuration of Contour Extraction Circuit

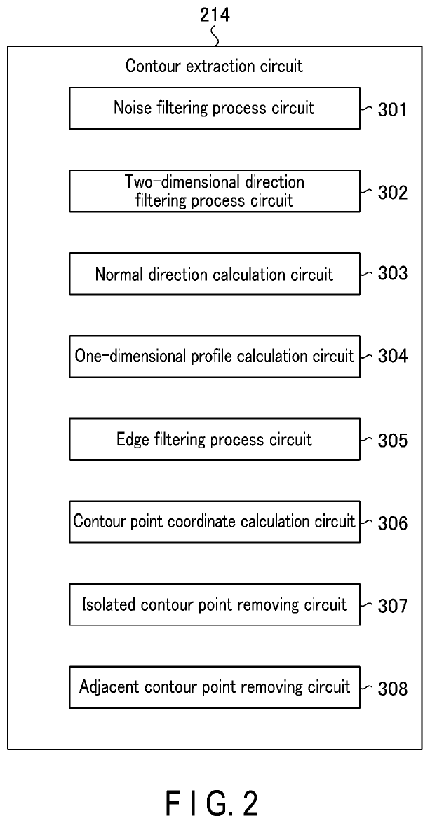

An example of the configuration of the contour extraction circuit 214 will be described below with reference to FIG. 2. FIG. 2 is a block diagram of the contour extraction circuit 214. Note that the function of each block of the contour extraction circuit 214 may be fulfilled by the control circuit 21 executing firmware or the like or may be fulfilled by a dedicated circuit.

As shown in FIG. 2, the contour extraction circuit 214 includes a noise filtering process circuit 301, a two-dimensional direction filtering process circuit 302, a normal direction calculation circuit 303, a one-dimensional profile calculation circuit 304, an edge filtering process circuit 305, a contour point coordinate calculation circuit 306, an isolated contour point removing circuit 307, and an adjacent contour point removing circuit 308. The data generated by each unit can be stored in the storage device 22 each time.

The noise filter processing circuit 301 removes (reduces) noise of SEM image data. The noise filter processing circuit 301 acquires SEM image data from the image acquisition circuit 213. Then, the noise filter processing circuit 301 removes (reduces) noise at the end of the graphic pattern of the SEM image to smooth the shape of the end of the pattern. For the noise filtering process, a general filter such as a Gaussian filter and a bilateral filter can be used.

The two-dimensional direction filtering process circuit 302 performs a two-dimensional direction filtering process in each pixel of image data after noise filter processing. The two-dimensional direction filtering process circuit 302 includes a plurality of two-dimensional direction filters having different directions (the direction will also be referred to as a filter angle hereinafter). A general filter such as a Laplacian filter can be used as the two-dimensional direction filter. Details of the two-dimensional direction filter will be described later. The two-dimensional direction filtering process circuit 302 performs a two-dimensional direction filtering process for each direction (filter angle) to calculate an intensity value for each filter angle (the intensity value after filtering will be referred to as a filtered intensity). The two-dimensional direction filtering process circuit 302 reads the intensity threshold data 224 from a storage device 22 to compare the filtered intensity and the intensity threshold value for each filter angle. Note that the intensity threshold value may be set to a different value for each filter angle. For example, the intensity threshold value is set for each filter angle based on the result of imaging a calibration pattern before inspection. The two-dimensional direction filtering process circuit 302 extracts a pixel having a filtered intensity value which is equal to or greater than the intensity threshold value as a candidate pixel including a contour point (hereinafter referred to as a contour point candidate pixel).

The normal direction calculation circuit 303 is a circuit that calculates the normal direction of a contour line in the contour point candidate pixel. The normal direction calculation circuit 303 converts the filtered intensity distribution of the filter angles into polar coordinates. The normal direction calculation circuit 303 calculates, as a normal direction, the major axis direction of an ellipse having the same secondary moment (referred to as an equivalent ellipse) from the result of the polar coordinate conversion.

The one-dimensional profile calculation circuit 304 calculates a one-dimensional profile in the normal direction of the contour point candidate pixel.

The edge filtering process circuit 305 performs an edge filtering process for the one-dimensional profile in the normal direction.

The contour point coordinate calculation circuit 306 calculates coordinates (positions) of a contour point in the contour point candidate pixel. The contour point coordinate calculation circuit 306 performs an interpolation process of the filtered intensity after the edge filtering process. The contour point coordinate calculation circuit 306 calculates the maximum value of the filtered intensity after the interpolation process as the coordinates of the contour point.

The isolated contour point removing circuit 307 removes isolated contour points. The isolated contour points are contour points the number of which is equal to or smaller than a preset number (e.g., one or two) in an area including a contour point candidate pixel including a target contour point and its surrounding pixels (e.g., 3-row×3-column pixels).

The adjacent contour point removing circuit 308 removes adjacent contour points. The adjacent contour points are contour points a distance between which is equal to or shorter than a preset distance.

### 3. Two-Dimensional Direction Filtering Process

Next is a description of a two-dimensional direction filtering process.

### 3.1 Filter Angle for Two-Dimensional Direction Filtering Process

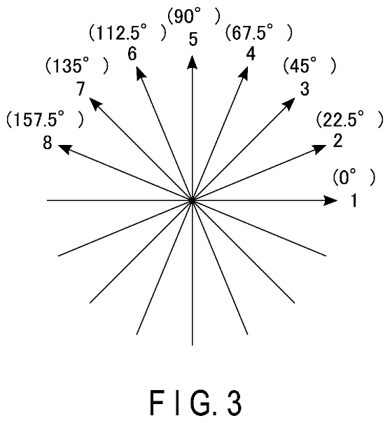

First, an example of the filter angle of a two-dimensional direction filter will be described with reference to FIG. 3. FIG. 3 is a diagram showing an example of the filter angle of a two-dimensional direction filter.

As shown in FIG. 3, eight two-dimensional direction filters corresponding to eight filter angles (directions) are used in the range of, for example, 0° to 180°. Assume that the number of each filter angle is i (i is an integer of 1 to 8). If i is equal to 1, a two-dimensional direction filter corresponding to the filter angle of 0° is used. If i is equal to 2, a two-dimensional direction filter corresponding to a filter angle of 22.5° is used. If i is equal to 3, a two-dimensional direction filter corresponding to a filter angle of 45° is used. If i is equal to 4, a two-dimensional direction filter corresponding to a filter angle of 67.5° is used. If i is equal to 5, a two-dimensional direction filter corresponding to a filter angle of 90° is used. If i is equal to 6, a two-dimensional direction filter corresponding to a filter angle of 112.5° is used. If i is equal to 7, a two-dimensional direction filter corresponding to a filter angle of 135° is used. If i is equal to 8, a two-dimensional direction filter corresponding to a filter angle of 157.5° is used.

### 3.2 Example of Display of Pixel Value of Each Pixel for Use in Two-Dimensional Direction Filtering Process

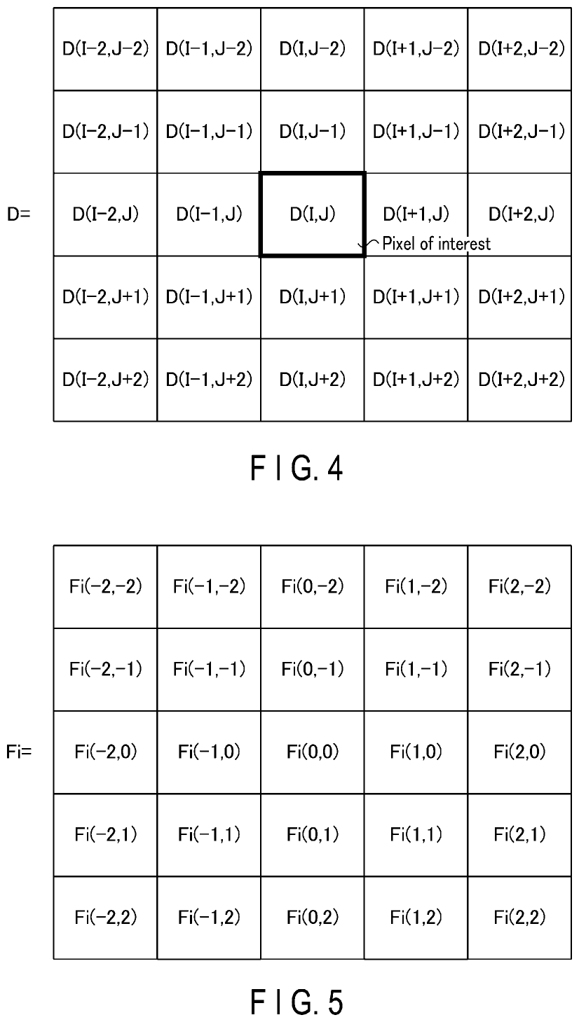

An example of a display of a pixel value of each pixel for use in the two-dimensional direction filtering process will be described below with reference to FIG. 4. FIG. 4 is a diagram showing an example of a display of a pixel value of each of 5×5 pixels with a pixel of interest centered.

As shown in FIG. 4, for example, a gradation value of 5-row×5-column pixels with a pixel of interest centered is used in the two-dimensional direction filtering process. If the coordinates of the pixel of interest are set to (X, Y)=(I, J) (where I and J are integers), the coordinates of the 5×5 pixels are represented by (X, Y)=(I−2, J−2) to (I+2, J+2) from the upper left of the figure to the lower right thereof. In this case, the gradation value D of each pixel is defined by D (I−2, J−2) to D (I+2, J+2).

### 3.3 Coordinates of Matrix Vector of Two-Dimensional Direction Filter

An example of display of coordinates of a matrix vector of the two-dimensional direction filter will be described below with reference to FIG. 5. FIG. 5 is a diagram showing an example of a display of the matrix vector of the two-dimensional direction filter.

As shown in FIG. 5, for example, 5×5 filters are used as two-dimensional filters. If the center coordinates are, for example, (0, 0), the coordinates of the filters are represented by (X, Y)=(−2, −2) to (2, 2) from the lower left of the figure to the upper right thereof. If, for example, the two-dimensional direction filter corresponding to the i-th filter angle is Fi, the values of the two-dimensional direction filter Fi are defined by Fi (−2, −2) to Fi (2, 2).

### 3.4 Specific Example of Two-Dimensional Direction Filter

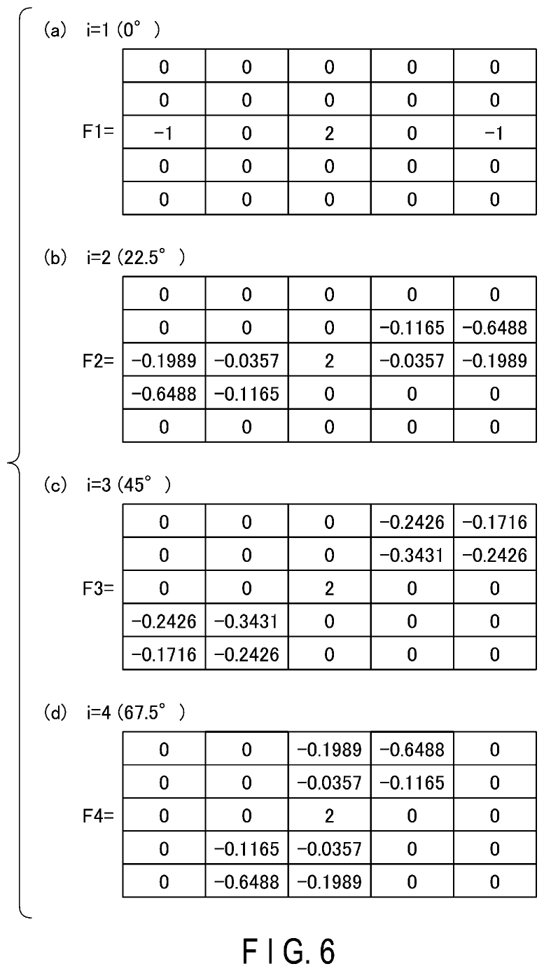

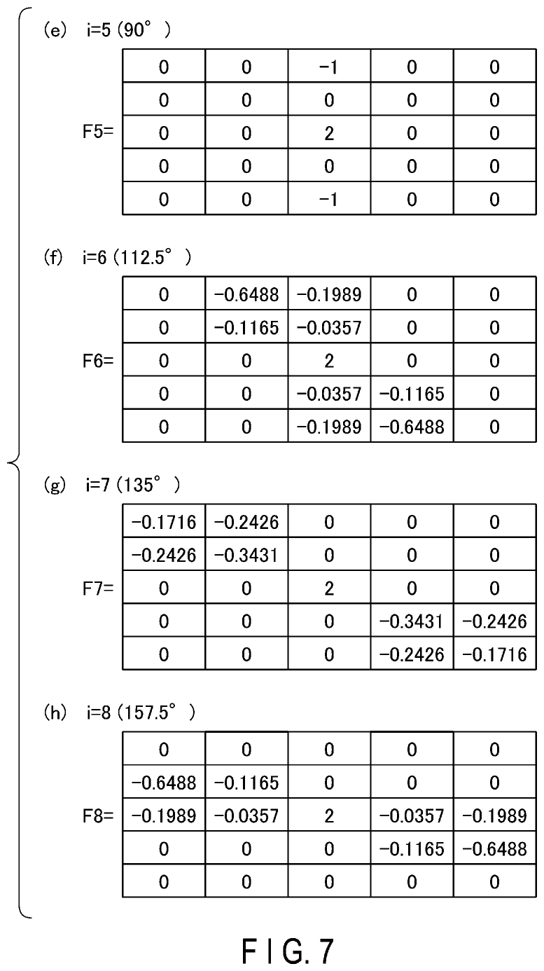

A specific example of the two-dimensional direction filter will be described with reference to FIGS. 6 and 7. FIG. 6 is a diagram showing specific examples of two-dimensional direction filters F1 to F4. FIG. 7 is a diagram showing specific examples of two-dimensional direction filters F5 to F8.

As shown in FIG. 6, for example, in the two-dimensional filter F1, the values of F1 (−2, −2), F1 (−1, −2), F1 (0, −2), F1 (1, −2), F1 (2, −2), F1 (−2, −1), F1 (−1, −1), F1 (0, −1), F1 (1, −1), F1 (2, −1), F1 (−1, 0), F1 (1, 0), F1 (−2, 1), F1 (−1, 1), F1 (0, 1), F1 (1, 1), F1 (2, 1), F1 (−2, 2), F1 (−1, 2), F1 (0, 2), F1 (1, 2), and F1 (2, 2) are set to 0. The values of F1 (−2, 0) and F1 (2, 0) are set to −1. The value of F1 (0, 0) is set to 2.

For example, in the two-dimensional filter F2, the values of F2 (−2, −2), F2 (−1, −2), F2 (0, −2), F2 (1, −2), F2 (2, −2), F2 (−2, −1), F2 (−1, −1), F2 (0, −1), F2 (0, 1), F2 (1, 1), F2 (2, 1), F2 (−2, 2), F2 (−1, 2), F2 (0, 2), F2 (1, 2), and F2 (2, 2) are set to 0. The values of F2 (1, −1) and F2 (−1, 1) are set to −0.1165. The values of F2 (2, −1) and F2 (−2, 1) are set to −0.6488. The values of F2 (−2, 0) and F2 (2, 0) are set to −0.1989. The values of F2 (−1, 0) and F2 (1, 0) are set to −0.0357. The value of F2 (0, 0) is set to 2.

For example, in the two-dimensional direction filter F3, the values of F3 (−2, −2), F3 (−1, −2), F3 (0, −2), F3 (−2, −1), F3 (−1, −1), F3 (0, −1), F3 (−2, 0), F3 (−1, 0), F3 (1, 0), F3 (2, 0), F3 (0, 1), F3 (1, 1), F3 (2, 1), F3 (0, 2), F3 (1, 2), and F3 (2, 2) are set to 0. The values of F3 (1, −2), F3 (2, −1), F3 (−2, 1) and F3 (−1, 2) are set to −0.2426. The values of F3 (2, −2) and F3 (−2, 2) are set to −0.1716. The values of F3 (1, −1) and F3 (−1, 1) are set to −0.3431. The value of F3 (0, 0) is set to 2.

For example, in the two-dimensional filter F4, the values of F4 (−2, −2), F4 (−1, −2), F4 (2, −2), F4 (−2, −1), F4 (−1, −1), F4 (2, −1), F4 (−2, 0), F4 (−1, 0), F4 (1, 0), F4 (2, 0), F4 (−2, 1), F4 (1, 1), F4 (2, 1), F4 (−2, 2), F4 (1, 2), and F4 (2, 2) are set to 0. The values of F4 (0, −2) and F4 (0, 2) are set to −0.1989. The values of F4 (1, −2) and F4 (−1, 2) are set to −0.6488. The values of F4 (0, −1) and F4 (0, 1) are set to −0.0357. The values of F4 (1, −1) and F4 (−1, 1) are set to −0.1165. The value of F4 (0, 0) is set to 2.

As shown in FIG. 7, for example, in the two-dimensional filter F5, the values of F5 (−2, −2), F5 (−1, −2), F5 (1, −2), F5 (2, −2), F5 (−2, −1), F5 (−1, −1), F5 (0, −1), F5 (1, −1), F5 (2, −1), F5 (−2, 0), F5 (−1, 0), F5 (1, 0), F5 (2, 0), F5 (−2, 1), F5 (−1, 1), F5 (0, 1), F5 (1, 1), F5 (2, 1), F5 (−2, 2), F5 (−1, 2), F5 (1, 2), and F5 (2, 2) are set to 0. The values of F5 (0, −2) and F5 (0, 2) are set to −1. The value of F5 (0, 0) is set to 2.

For example, in the two-dimensional filter F6, the values of F6 (−2, −2), F6 (1, −2), F6 (2, −2), F6 (−2, −1), F6 (1, −1), F6 (2, −1), F6 (−2, 0), F6 (−1, 0), F6 (1, 0), F6 (2, 0), F6 (−2, 1), F6 (−1, 1), F6 (2, 1), F6 (−2, 2), F6 (−1, 2), and F6 (2, 2) are set to 0. The values of F6 (−1, −2) and F6 (1, 2) are set to −0.6488. The values of F6 (0, −2) and F6 (0, 2) are set to −0.1989. The values of F6 (−1, −1) and F6 (1, 1) are set to −0.1165. The values of F6 (0, −1) and F6 (0, 1) are set to −0.0357. The value of F6 (0, 0) is set to 2.

For example, in the two-dimensional direction filter F7, the values of F7 (0, −2), F7 (1, −2), F7 (2, −2), F7 (0, −1), F7 (1, −1), F7 (2, −1), F7 (−2, 0), F7 (−1, 0), F7 (1, 0), F7 (2, 0), F7 (−2, 1), F7 (−1, 1), F7 (0, 1), F7 (−2, 2), F7 (−1, 2), and F7 (0, 2) are set to 0. The values of F7 (−2, −2) and F7 (2, 2) are set to −0.1716. The values of F7 (−1, −2), F7 (−2, −1), F7 (2, 1), and F7 (1, 2) are set to −0.2426. The values of F7 (−1, −1) and F7 (1, 1) are set to −0.3431. The value of F7 (0, 0) is set to 2.

For example, in the two-dimensional direction filter F8, the values of F8 (−2, −2), F8 (−1, −2), F8 (0, −2), F8 (1, −2), F8 (2, −2), F8 (0, −1), F8 (1, −1), F8 (2, −1), F8 (−2, 1), F8 (−1, 1), F8 (0, 1), F8 (−2, 2), F8 (−1, 2), F8 (0, 2), F8 (1, 2), and F8 (2, 2) are set to 0. The values of F8 (−2, −1) and F8 (2, 1) are set to −0.6488. The values of F8 (−1, −1) and F8 (1, 1) are set to −0.1165. The values of F8 (−2, 0) and F8 (2, 0) are set to −0.1989. The values of F8 (−1, 0) and F8 (1, 0) are set to −0.0357. The value of F8 (0, 0) is set to 2.

### 3.5 Arithmetic Expression for Two-Dimensional Direction Filtering Process

Next is a description of the arithmetic expression of a filtering process in each of the two-dimensional direction filters F1 to F8. The two-dimensional direction filter processing circuit 302 performs an arithmetic operation of expression (1) and performs a convolution operation of the two-dimensional direction filter Fi and the pixel of interest.

$$\begin{matrix}( Expression 1 ) & \\ In\_i = D * Fi & ( 1 )\end{matrix}$$

In the above expression, In_i indicates the filtered intensity by the two-dimensional direction filter Fi, D denotes a gradation value of the pixel, and an asterisk (*) indicates a convolution operation. Assuming that the coordinates of the pixel of interest are (X, Y)=(I, J) as described with reference to FIG. 4, the arithmetic operation of expression (1) can be expressed as expression (2).

$$\begin{matrix}( Expression 2 ) & \\ In\_i ( I , J ) = {\sum }_{k = - 2}^{2} {\sum }_{l = - 2}^{2} D ( I + k , J + l ) Fi ( k , l ) & ( 2 )\end{matrix}$$

In the above expression, k is an integer of −2 to 2 indicating an amount of shift from coordinates I and l is an integer of −2 to 2 indicating an amount of shift from coordinates J.

More specifically, the expression (2) is given by the following:
In_i=D (I−2, J−2) Fi (−2, −2)+D (I−1, J−2) Fi (−1, −2)+D (I, J−2) Fi (0, −2)+D (I+1, J−2) Fi (1, −2)+D (I+2, J−2) Fi (2, −2)+D (I−2, J−1) Fi (−2, −1)+D (I−1, J−1) Fi (−1, −1)+D (I, J−1) Fi (0, −1)+D (I+1, J−1) Fi (1, −1)+D (I+2, J−1) Fi (2, −1)+D (I−2, J) Fi (−2, 0)+D (I−1, J) Fi (−1, 0)+D (I, J) Fi (0, 0)+D (I+1, J) Fi (1, 0)+D (I+2, J) Fi (2, 0)+D (I−2, J+1) Fi (−2, 1)+D (I−1, J+1) Fi (−1, 1)+D (I, J+1) Fi (0, 1)+D (I+1, J+1) Fi (1, 1)+D (I+2, J+1) Fi (2, 1)+D (I−2, J+2) Fi (−2, 2)+D (I−1, J+2) Fi (−1, 2)+D (I, J+2) Fi (0, 2)+D (I+1, J+2) Fi (1, 2)+D (I+2, J+2) Fi (2, 2)

### 4 Flow of Overall Inspection Process

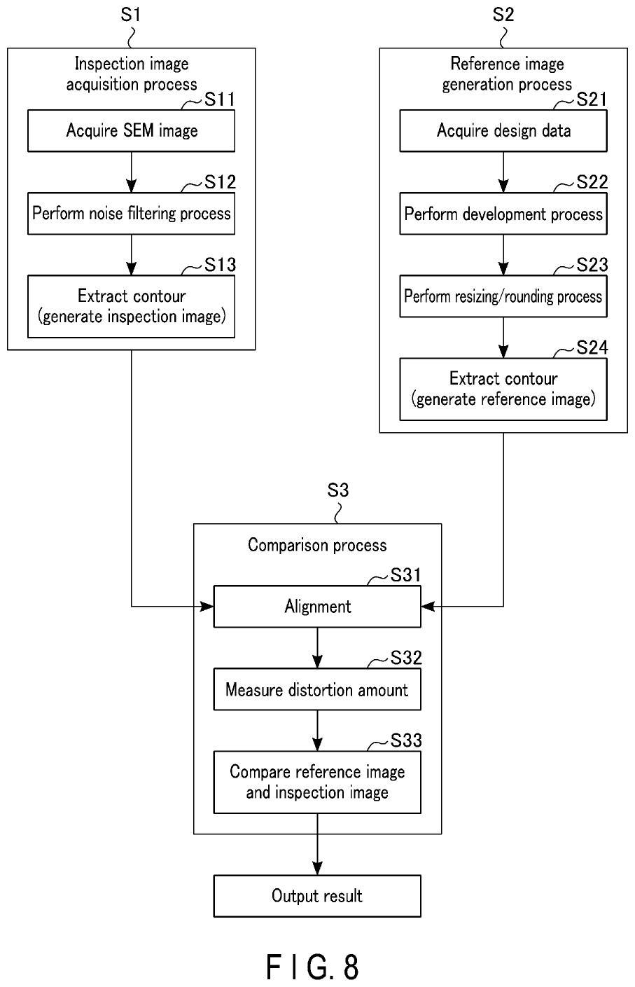

A flow of overall inspection process will be described with reference to FIG. 8. FIG. 8 is a flowchart of an inspection process.

As shown in FIG. 8, the inspection process roughly includes an inspection image acquisition process (step S1), a reference image generation process (step S2) and a comparison process (step S3).

### 4.1 Inspection Image Acquisition Process

First is a description of an example of the inspection image acquisition process in step S1. The image acquisition circuit 213 acquires an SEM image of the sample 30 from the imaging mechanism 10 (step S11). The image acquisition circuit 213 transmits the SEM image to the contour extraction circuit 214.

Then, the contour extraction circuit 214 performs a noise filtering process to remove noise from the SEM image (step S12).

Then, the contour extraction circuit 214 extracts the contour of a pattern from the SEM image after the noise filtering process (step S13) to generate an inspection image (contour image). That is, the contour extraction circuit 214 extracts a contour line and a plurality of contour points for each graphic pattern.

The contour extraction circuit 214 transmits the generated inspection image to the comparison circuit 215 and the storage device 22.

### 4.2 Reference Image Acquisition Process

Next is a description of an example of the reference image acquisition process. For example, the inspection apparatus 1 acquires the design data 221 via the communication device 25 (step S21). The acquired design data 221 is stored, for example, in the storage device 22.

The development circuit 211 reads the design data 221 from the storage device 22. Then, the development circuit 211 performs a development process to develop (convert) the design data 221 into, for example, 8-bit image data (developed image) (step S22). Each pixel of the developed image has, as a pixel value, a value corresponding to the occupancy rate at which the pixel is occupied by the figure of the design data 221. In the case of the 8-bit image data, the pixel value is 0 when the occupancy rate is 0%, and it is 255 when the occupancy rate is 100%. The development circuit 211 transmits the developed image to the reference image generation circuit 212 and the storage device 22.

Then, the reference image generation circuit 212 performs a resizing process and a corner rounding process for the developed image (step S23).

Then, the reference image generation circuit 212 extracts the contour of a pattern from the developed image that is subjected to the resizing process and the corner rounding process (step S24) to generate a reference image (contour image). The reference image generation circuit 212 transmits the generated reference image to the comparison circuit 215 and the storage device 22.

### 4.3 Comparison Process

Next is a description of an example of the comparison process. First, the comparison circuit 215 aligns the pattern in the inspection image and the pattern in the reference image using an inspection image and a reference image (step S31). For example, the comparison circuit 215 obtains relative vectors between the contour line positions of the inspection image and their corresponding contour line positions of the reference image, and uses the average value of the relative vectors as an alignment shift amount. That is, the comparison circuit 215 calculates the alignment shift amount of the inspection image relative to the reference image.

Then, the comparison circuit 215 measures the amount of distortion of the inspection image (step S32) to calculate a distortion coefficient. For example, a positional deviation may occur between pattern coordinate information based on the design data 221 and pattern coordinates calculated from a captured image due to stage movement accuracy, distortion of the sample 30, or the like. The comparison circuit 215 measures, for example, the amount of distortion of the inspection image from the distribution of local alignment shift amounts in the plane of the sample 30 to calculate a distortion coefficient.

Then, the comparison circuit 215 compares the inspection image and the reference image (step S33). The comparison circuit 215 detects a defect based on a result of the comparison. In other words, the comparison circuit 215 calculates the amount of positional deviation between the contour line of the inspection image and that of the reference image for each pixel based on the relative vector and the distortion coefficient. Then, the comparison circuit 215 detects a defect based on the amount of positional deviation. The result of the comparison is output to the storage device 22 or the display device (monitor) 23.

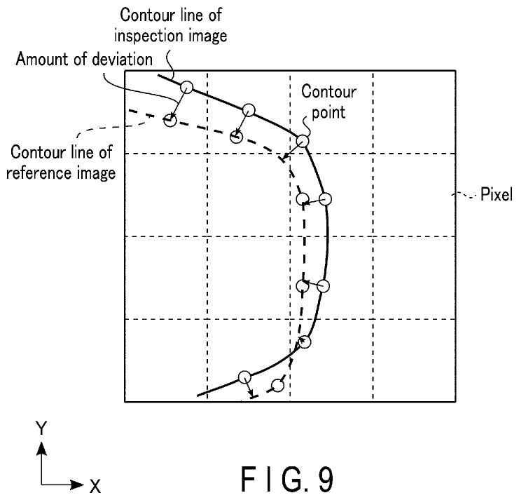

FIG. 9 shows a specific example of comparison between an inspection image and a reference image. FIG. 9 is a diagram showing a specific example of 4×4 pixels including a contour line of the inspection image and that of the reference image.

As shown in FIG. 9, the comparison circuit 215 calculates a distance (positional deviation amount) to the contour line of the reference image for each contour point of the inspection image. Then, the comparison circuit 215 determines that there is a defect if the positional deviation amount exceeds a preset threshold value.

After the control circuit 21 stores a result of the defect inspection in the storage device 22, the control circuit 21 may display the result on the display device 23, for example, or may output it to an external device (e.g., a review device) via the communication device 25.

### 5 Details of Contour Extraction Process

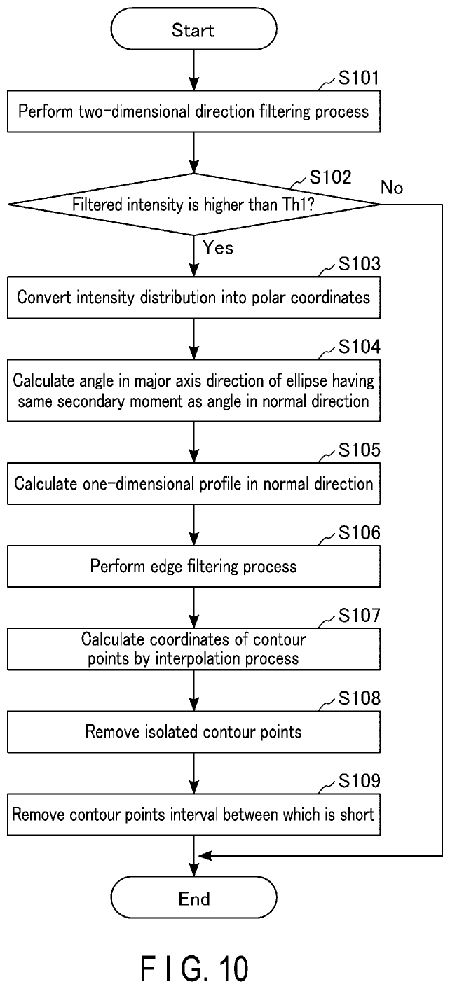

The contour extraction process in step S13 will be described in detail below with reference to FIG. 10. FIG. 10 is a flowchart of the contour extraction process.

As shown in FIG. 10, the process of steps S101 to S109 is performed as the contour extraction process for each pixel of the SEM image (captured image) after the noise filtering process. Details of each of the steps will be described.

### (Step S101)

The two-dimensional direction filtering process circuit 302 performs a two-dimensional direction filtering process corresponding to each of a plurality of directions (filter angles) in each pixel of the SEM image after the noise filtering process. Then, the two-dimensional direction filtering process circuit 302 compares the filtered intensity and the intensity threshold value for each of the filter angles.

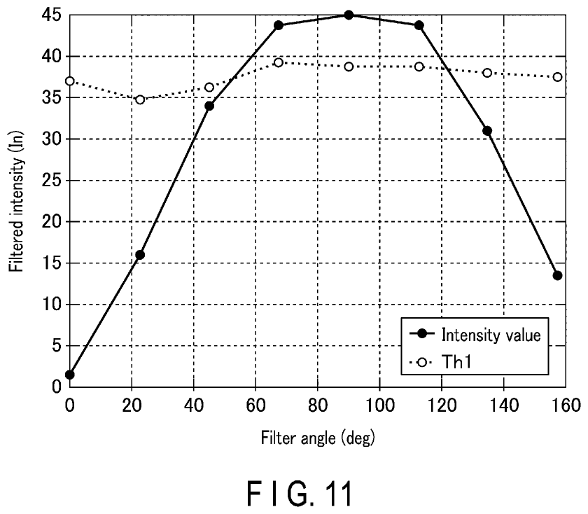

A specific example of a two-dimensional direction filtering process using two-dimensional direction filters F1 to F8 in eight directions will be described with reference to FIG. 11. FIG. 11 is a graph showing the relationship between the filter angle and the filtered intensity.

As shown in FIG. 11, the two-dimensional filtering process circuit 302 performs a filtering process to calculate the filtered intensity at each filter angle of the eight filters. In the example of FIG. 11, the value of the filtered intensity is maximized when the filter angle of the two-dimensional direction filter F5 is 90°.

A different intensity threshold value Th1 is set for each filter angle. In the example of FIG. 11, the intensity threshold value Th1 at the filter angle of 22.5° (i=2) is set to be the lowest, and the intensity threshold value Th1 at the filter angle of 67.5° (i=4) is set to be the highest.

The two-dimensional direction filtering process circuit 302 compares the filtered intensity and the intensity threshold value Th1 at each filter angle. In the example of FIG. 11, the filtered intensity is higher than the intensity threshold value Th1 at the filter angles of 67.5° (i=4), 90° (i=5), and 112.5° (i=6).

### (Step S102)

The contour extraction circuit 214 checks whether there is filtered intensity greater than the intensity threshold value Th1. If there is no filter angle whose filtered intensity is higher than the intensity threshold value Th1 (No in step S102), the contour extraction circuit 214 determines that the pixel does not correspond to the contour point candidate pixel, and terminates the contour extraction for the pixel.

On the other hand, if there is a filter angle whose filtered intensity is higher than the intensity threshold value Th1 (Yes in step S102), the contour extraction circuit 214 extracts the pixel as a contour point candidate pixel.

### (Step S103)

The normal direction calculation circuit 303 displays the intensity distribution with the filtered intensity and the filter angle as polar coordinates. Assume that for example, the i-th filtered intensity is In_i and the filter angle is Si. If the polar coordinates (In_i, Si) are converted into XY coordinates, they are expressed as (X, Y)=(In_i·cos (Si), In_i·sin (Si)). Since the filter angle is in the range of 0° to 180°, the filter angle of 180° to 360° is set as the origin symmetry of the filter angle of 0° to 180°. The filtered intensity is set to a value that is equal to the filter angle of the origin symmetry. More specifically, the number of the filter angles of the origin symmetry is set to i=9 to 16 with respect to the eight filter angle numbers i=1 to 8, in the range of 0° to 180° described with reference to FIG. 3. The number i=9 is the origin symmetry of i=1. The filter angle of i=9 is S9=0° (S1)+180°=180°, and the filtered intensity is expressed as In_9=In_1. The number i=10 is the origin symmetry of i=2. The filter angle of i=10 is S10=22.5° (S2)+180°=202.5°, and the filtered intensity is expressed as In_10=In_2. The number i=11 is the origin symmetry of i=3. The filter angle of i=11 is S11=45° (S3)+180°=225°, and the filtered intensity is expressed as In_11=In_3. The number i=12 is the origin symmetry of i=4. The filter angle of i=12 is S12=67.5° (S4)+180°=247.5°, and the filtered intensity is expressed as In_12=In_4. The number i=13 is the origin symmetry of i=5. The filter angle of i=13 is S13=90° (S5)+180°=270°, and the filtered intensity is expressed as In_13=In_5. The number i=14 is the origin symmetry of i=6. The filter angle of i=14 is S14=112.5° (S6)+180°=292.5°, and the filtered intensity is expressed as In_14=In_6. The number i=15 is the origin symmetry of i=7. The filter angle of i=15 is S15=135° (S7)+180°=315°, and the filtered intensity is expressed as In_15=In_7. The number i=16 is the origin symmetry of i=8. The filter angle of i=16 is S16=157.5° (S8)+180°=337.5°, and the filtered strength is expressed as In_16=In_8.

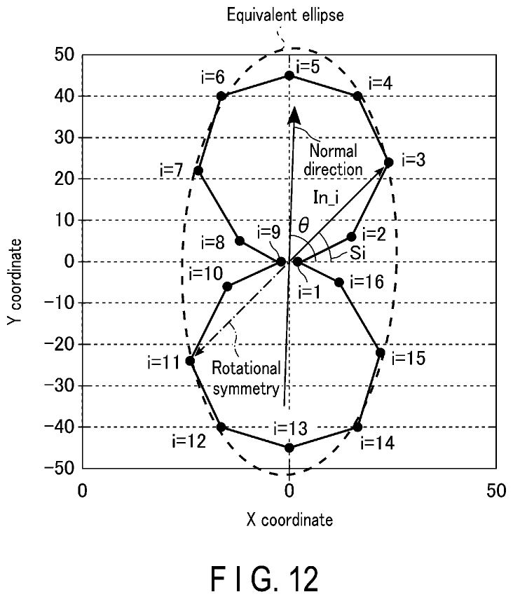

FIG. 12 shows a specific example of display of the converted polar coordinates. FIG. 12 is a graph showing polar coordinates into which the relationship between the filtered intensity and filter angle shown in FIG. 11 is converted.

As shown in FIG. 12, the intensity distribution is formed in a bipolar shape by the polar coordinates. The ellipse indicated by the broken line is an equivalent ellipse corresponding to the intensity distribution that is formed in a bipolar shape.

### (Step S104)

The normal direction calculation circuit 303 calculates the angle in the major axis direction of the equivalent ellipse, as the angle in the normal direction to the contour line, from the second moment of the filtered intensity converted into polar coordinates.

More specifically, the normal direction calculation circuit 303 performs an arithmetic operation of expression 3 to calculate second moment M20 in the X direction, that is, a variance of X.

$$\begin{matrix}( Expression 3 ) & \\ M 20 = \frac{{\sum }_{i = 1}^{16} {Xi}^{2}}{16} - {( \frac{{\sum }_{i = 1}^{16} Xi}{16} )}^{2} & ( 3 )\end{matrix}$$

The normal direction calculation circuit 303 performs an arithmetic operation of expression 4 to calculate second moment M02 in the Y direction, that is, a variance of Y.

$$\begin{matrix}( Expression 4 ) & \\ M 02 = \frac{{\sum }_{i = 1}^{16} {Yi}^{2}}{16} - {( \frac{{\sum }_{i = 1}^{16} Yi}{16} )}^{2} & ( 4 )\end{matrix}$$

The normal direction calculation circuit 303 performs an arithmetic operation of expression 5 to calculate XY cross moment M11, that is, a covariance of XY.

$$\begin{matrix}( Expression 5 ) & \\ M 11 = \frac{{\sum }_{i = 1}^{16} XiYi}{16} - ( \frac{{\sum }_{i = 1}^{16} Xi}{16} ) ( \frac{{\sum }_{i = 1}^{16} Yi}{16} ) & ( 5 )\end{matrix}$$

Then, the normal direction calculation circuit 303 performs an arithmetic operation of expression 6 to calculate angle θ in the principal axis direction, that is, in the normal direction.

$$\begin{matrix}( Expression 6 ) & \\ θ = mod ( atan 2 ( 2 \times M 11 , ( M 20 - M 02 ) ) / 2 , pi ) & ( 6 )\end{matrix}$$

In expression 6, mod represents a function of modulus operation. In the case of mod (a, b), the answer is the remainder obtained by dividing a by b. When neither a nor b is an integer, the general equation is expressed as mod (a, b)=a−floor (a/b)×b. In expression 6, floor (c) represents an integer that is smaller than c and nearest to c, “x” represents multiplication and “/” represents division, and atan 2 represents an arctangent function. The answer to the function of atan 2 is given in radians in the range of −π to π. Note that the order of arguments in the parentheses of atan 2 in expression 6 corresponds to a programming language such as C, C++, and Fortran. In expression 6, pi represents the circular constant (π). If the value obtained from expression 6 is converted to a degree measure (°), the normal angle is expressed as θ=88° in the example of FIG. 12.

### (Step S105)

The one-dimensional profile calculation circuit 304 calculates a one-dimensional profile in the normal direction with the center of the contour point candidate pixel as the origin. More specifically, first, the one-dimensional profile calculation circuit 304 extracts sampling points at pixel intervals in the normal direction with the center of the contour point candidate pixel as the origin.

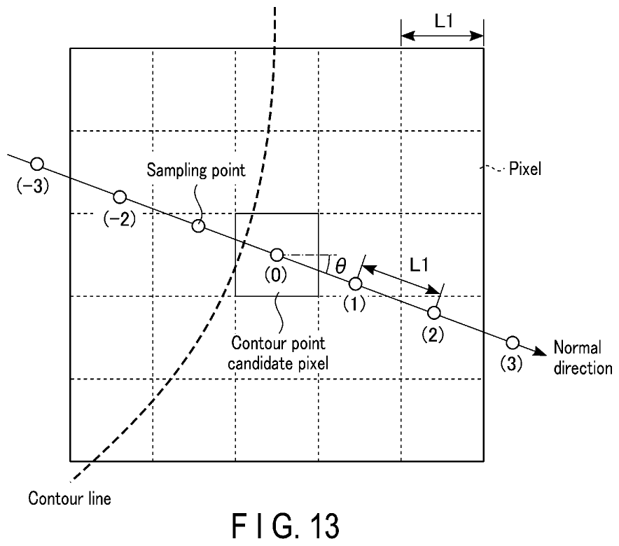

FIG. 13 shows a specific example of extraction of sampling points. FIG. 13 is a diagram showing a specific example of extraction of sampling points. In the example of FIG. 13, 5×5 pixels with the contour point candidate pixel centered are shown.

As shown in FIG. 13, the one-dimensional profile calculation circuit 304 sets, as one-dimensional coordinates, the normal direction with the center of the contour point candidate pixel as the origin (0). Then, the one-dimensional profile calculation circuit 304 extracts a plurality of sampling points at pixel intervals in the + direction and the − direction. If the width of one pixel is L1, the distance between two sampling points is L1. In the example of FIG. 13, sampling points of coordinates (1), (2) and (3) are extracted with the right side of the drawing from the origin as the + direction. Similarly, sampling points of coordinates (−1), (−2) and (−3) are extracted with the left side of the drawing as the − direction. It is preferable that the number of sampling points to be extracted be 11 or more including the contour point candidate pixel in consideration of the process to be described later.

Then, the one-dimensional profile calculation circuit 304 calculates a gradation value (brightness value) at each of the sampling points to create a one-dimensional profile in the normal direction. More specifically, the positions of the sampling points are set in units of sub-pixels into which one pixel is divided. For example, the one-dimensional profile calculation circuit 304 calculates a gradation value at each sampling point using, for example, bicubic interpolation using surrounding 4×4 pixels (16 pixels).

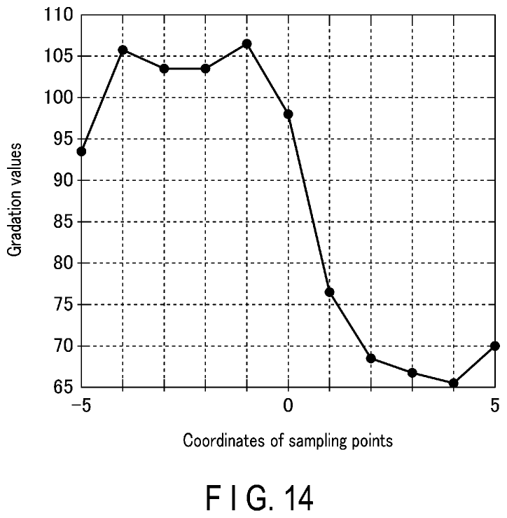

FIG. 14 shows a specific example of gradation values at the sampling points. FIG. 14 is a graph showing a specific example of gradation values at the sampling points.

In the example of FIG. 14, eleven sampling points (−5) to (5) are extracted with the sampling point of the contour point candidate pixel as a coordinate (0). The sampling point of the coordinate (−1) has the highest gradation value and the sampling point of the coordinate (4) has the lowest gradation value.

### (Step S106)

The edge filter processing circuit 305 performs an edge filtering process of gradation values of the sampling points.

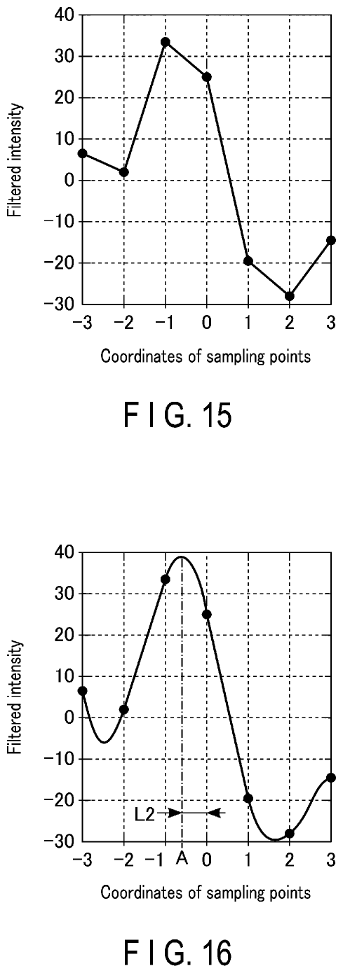

FIG. 15 shows a specific example of an edge filtering process. FIG. 15 is a graph showing a specific example of the filtered intensity after the edge filtering process of the one-dimensional profile shown in FIG. 14.

The example of FIG. 15 indicates a result of convolution operation performed using 1×5 one-dimensional filters (−1, 0, 2, 0, −1) as the edge filtering process.

### (Step S107)

The contour point coordinate calculation circuit 306 performs an interpolation process of the filtered intensity after the edge filtering process to calculate the coordinates of a contour point. More specifically, first, the contour point coordinate calculation circuit 306 performs an interpolation process of the filtered intensity of each sampling point. For example, spline interpolation is used as the interpolation process. The contour point coordinate calculation circuit 306 calculates coordinate where the filtered intensity has a maximum value as the coordinate of the contour point from a result of the interpolation process.

FIG. 16 shows a specific example of the spline interpolation. FIG. 16 is a graph showing a specific example in which spline interpolation is applied to the filtered intensity shown in FIG. 15.

As shown in FIG. 16, for example, the contour point coordinate calculation circuit 306 sets, as (A), the coordinate in which the filtered intensity is maximized after the spline interpolation. Then, the distance from the origin (0) to the coordinate (A) is set as L2. In the example of FIG. 16, the filtered intensity has a maximum value at the coordinate (A) located at distance L2 in the − direction.

The contour point coordinate calculation circuit 306 converts the coordinate (A) of distance L2 in the normal direction from polar coordinates (L2, 0) to XY coordinates to calculate the coordinate of the contour points.

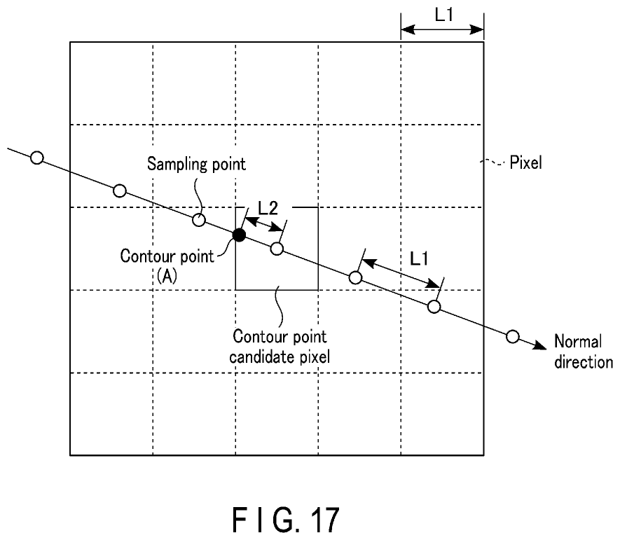

FIG. 17 shows a specific example of the coordinate of the contour point. FIG. 17 is a diagram showing a specific example in which the maximum value of the filtered intensity by the spline interpolation shown in FIG. 16 is set as a contour point. In the example of FIG. 17, 5×5 pixels with the contour point candidate pixel centered are shown.

As shown in FIG. 17, a contour point is calculated at a position corresponding to distance L2 in the normal direction of the − direction.

### (Step S108)

The isolated contour point removing circuit 307 removes an isolated contour point.

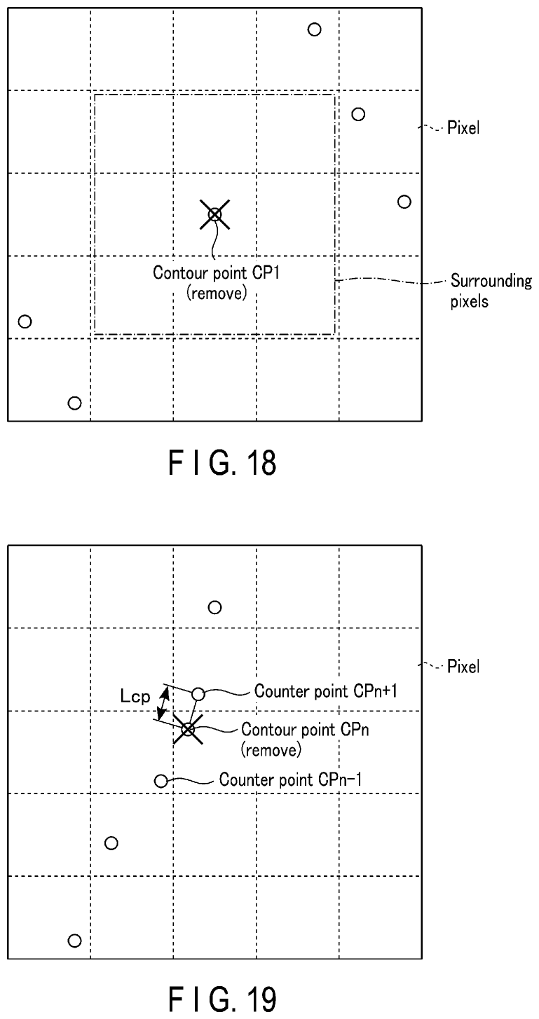

FIG. 18 shows a specific example of an isolated contour point. FIG. 18 is a diagram showing a specific example of an isolated contour point. In the example of FIG. 18, 5×5 pixels with an isolated contour point centered are shown.

As shown in FIG. 18, for example, the isolated contour point removing circuit 307 sets, as target pixels, the surrounding 3×3 pixels of a contour point CP1 targeted for checking an isolated contour point. Then, the isolated contour point removing circuit 307 compares the number of contour points included in the target pixels with a preset threshold value. Assume that the threshold value is, for example, 2. In the example of FIG. 18, the number of contour points in the target pixels is 1, which is smaller than the threshold value. Thus, the isolated contour point removing circuit 307 removes the contour point CP1 as an isolated contour point.

### (Step S109)

The adjacent contour point removing circuit 308 removes an adjacent contour point. If a distance between a target contour point and its adjacent contour point is less than a preset threshold value, the adjacent contour point removing circuit 308 removes the target contour point as an adjacent contour point.

FIG. 19 shows a specific example of an adjacent contour point. FIG. 19 is a diagram showing a specific example of an adjacent contour point. In the example of FIG. 19, 5×5 pixels with an adjacent contour point centered are shown.

As shown in FIG. 19, for example, the adjacent contour point removing circuit 308 calculates a distance between adjacent contour points CPn−1 and CPn+1 with respect to a contour point CPn (n is an optional integer) for checking an adjacent contour point. Since, in the example of FIG. 19, a distance Lcp between the contour point CPn and the contour point CPn+1 is less than a threshold value, the contour point CPn is removed.

The contour extraction circuit 214 defines pixels including the remaining contour points as contour pixels. The contour extraction circuit 214 generates a contour line from the contour points of the contour pixels.

### 6. Advantageous Effects of Embodiment

In the inspection apparatus, when a contour line and contour points of a pattern are extracted from a captured image, asymmetry may be caused in an image profile, for example, due to the influence of the scanning direction of an electron beam or the shape of the pattern. In this case, a filter angle dependence occurs in the filtered intensity after a two-dimensional direction filtering process. For example, when the filtered intensity is calculated from a hole image of a perfect circle, it is ideally constant regardless of the filter angle. If, however, there is asymmetry in the image profile, the filtered intensity varies depending on the filter angle. If the intensity threshold value is constant regardless of the filter angle, the intensity threshold value needs to be set in accordance with the filter angle at which the sensitivity of the filtered intensity is low. Accordingly, the intensity threshold value is set to a relatively low value, and the possibility of erroneously extracting a contour point candidate pixel increases. That is, the possibility of generating a false contour increases. In a method in which the filter angle at which the filtered intensity is maximized is set to the angle in the normal direction, angular resolution in the normal direction is low. In addition, the asymmetry of the image profile increases the possibility of calculating an erroneous filter angle as the angle in the normal direction.

With the configuration according to the present embodiment, the inspection apparatus can set a different intensity threshold value for each filter angle. Thus, even if asymmetry is caused in an image profile, a contour point candidate pixel can be suppressed from being extracted erroneously. Also, the inspection apparatus can calculate the angle in the major axis direction of an equivalent ellipse as the angle in the normal direction based on a result of converting the relationship between the filtered intensity and the filter angle into polar coordinates. Thus, the angular resolution in the normal direction can be improved, and the angle in the normal direction can be suppressed from being calculated erroneously. Therefore, the extraction accuracy of the contour line of an inspection image can be improved.

### 7. Modification

The foregoing embodiment is directed to a case where an inspection image is generated in the inspection apparatus. The method of generating an inspection image is not limited to the inspection apparatus. The method may be applied to other apparatuses, such as an apparatus for generating an inspection image based on image data, for example, a measurement apparatus.

While certain embodiments have been described, these embodiments have been presented by way of example only, and are not intended to limit the scope of the claims. Indeed, the novel methods and systems described herein may be embodied in a variety of other forms; furthermore, various omissions, substitutions and changes in the form of the methods and systems described herein may be made without departing from the spirit of the embodiments. The accompanying claims and their equivalents are intended to cover such forms or modifications as would fall within the scope and spirit of the embodiments.

What is claimed is:

1. An inspection apparatus comprising:
an imaging mechanism configured to capture an image of a wafer or a mask;
a two-dimensional direction filtering process circuit configured to perform a filtering process for each of pixels of the image, using a plurality of two-dimensional direction filters corresponding to different filter angles;
a contour extraction circuit configured to extract, as a contour point candidate pixel, a pixel in which at least one of intensities for each of the filter angles calculated by the filtering process is larger than a threshold value set for each of the filter angles;
a normal direction calculation circuit configured to convert the intensities for each of the filter angles into polar coordinates in the contour point candidate pixel and calculate an angle in a first direction based on a result of the conversion into polar coordinates;
a contour point coordinate calculation circuit configured to calculate coordinates of a contour point in the contour point candidate pixel, based on a one-dimensional profile in the first direction;
a reference image generation circuit configured to generate a reference image; and
a comparison circuit configured to compare the reference image with an inspection image based on the contour point.

2. The inspection apparatus according to claim 1, wherein the normal direction calculation circuit is configured to calculate an angle in a direction of a major axis of an equivalent ellipse of the polar coordinates as the angle in the first direction.

3. The inspection apparatus according to claim 1, further comprising a one-dimensional profile calculation circuit configured to set a plurality of sampling points at size intervals of the pixels along the first direction with a center position of the contour point candidate pixel as an origin and calculate a pixel value for each of the sampling points.

4. The inspection apparatus according to claim 1, wherein the contour point coordinate calculation circuit is configured to perform an edge filtering process for the one-dimensional profile and then perform spline interpolation of values calculated by the edge filtering process.

5. The inspection apparatus according to claim 4, wherein the contour point coordinate calculation circuit is configured to set, as the coordinates of the contour point, a position having a maximum value as a result of the spline interpolation.

6. A method for generating an inspection image, comprising:
performing a filtering process for each of pixels of a captured image of a wafer or a mask, using a plurality of two-dimensional direction filters corresponding to different filter angles;
extracting, as a contour point candidate pixel, a pixel in which at least one of intensities for each of the filter angles calculated by the filtering process is larger than a threshold value set for each of the filter angles;
converting the intensities for each of the filter angles into polar coordinates in the contour point candidate pixel;
calculating an angle in a first direction based on a result of the conversion into polar coordinates; and
calculating coordinates of a contour point in the contour point candidate pixel, based on a one-dimensional profile in the first direction.

7. The method according to claim 6, wherein the calculating the angle in the first direction includes calculating an angle in a direction of a major axis of an equivalent ellipse of the polar coordinates as the angle in the first direction.

8. The method according to claim 6, wherein the calculating the one-dimensional profile includes setting a plurality of sampling points at size intervals of the pixels along the first direction with a center position of the contour point candidate pixel as an origin, and calculating a pixel value for each of the sampling points.

9. The method according to claim 6, further comprising:
performing an edge filtering process of the one-dimensional profile; and
performing spline interpolation of values calculated by the edge filtering process.

10. The method according to claim 6, wherein the calculating coordinates of contour points includes calculating a position having a maximum value as a result of the spline interpolation, as the coordinates of the contour point.
